(19) United States
(12) Patent Application Publication
(10) Pub. No.: US 2002/0086603 A1
(43) Pub. Date: Jul. 4, 2002

(54) Heat-preserving compound fiber cloth and manufacturing process thereof

(76) Inventor: Zhao Lin Yu, Arcadia, CA (US)

Correspondence Address: Raymond Yat Chan, 1050 Oakdale Ave., Arcadia, CA, 91006, US

(21) Appl. No.: 09/751,622

(22) Filed: Dec. 29, 2000

(51) Int. Cl. B32B 27/12

(52) U.S. Cl. 442/396; 442/394

(57) ABSTRACT

A heat-preserving compound fiber cloth includes a sheet of outer fabric, a sheet of inner fabric, and a sheet of heat insulating layer having a predetermined uniform thickness. The heat insulating layer includes at least a fiber layer which includes a plurality of fiber filaments bonded on a construction film having flexible ability and permeability, wherein the construction film firmly and integrally holds the fiber filaments of the fiber layer together in such a manner that the heat insulating layer is adapted for being stretched and retaining an original shape. The heat insulating layer is bonded between the outer fabric and the inner fabric to form the heat-preserving compound fiber cloth. Accordingly, the heat-preserving compound fiber cloth provides better heat insulation and flexibility while having a minimum thickness for making interior wears, such as vests, long johns, sweaters and underwears.

### BACKGROUND OF THE PRESENT INVENTION

1. Field of Invention

The present invention relates to a compound fiber cloth, and more particularly to a heat-preserving compound fiber cloth and a manufacturing process thereof, which is adapted for providing good heat insulation for a wearer. Moreover, the present invention may also provide good humidity-conducting ability, which provides porosity to air, sufficient to avoid heat discomfort and perspiration of the wearer during exercising.

2. Description of Related Arts

It is well known that clothes, which are composed of compound textile material, are used for not only covering our body but also keeping warm. During winter, people are used to wear clothes to maintain their body temperature. However, when people wear more pieces of clothes especially jacket, they may merely reduce their activities.

On the other hand, during exercise, their bodies will release heat energy such as perspiration. So, they may feel discomfortable since the heat may be trapped by the clothes that cannot transfer to the atmosphere.

Referring to FIG. 1, a conventional compound textile material, for making coats and jackets, comprises an outer cloth 1, an inner lining 2, and a fiber insulating layer 3 mounted between the outer cloth 1 and the inner lining 2, wherein the fiber layer 3 is made of heat preservative material such as cotton, silk floss, synthetic fibers, ostrich, and etc. For constructing a jacket as shown in FIG. 1, the cotton made fiber layer 3 is milled with a predetermined thickness and is tightly mounted between the outer cloth 1 and the inner lining 2. Alternatively, if nonwoven fabrics of wool, fur or hair are used as the raw material, they are matted together by heat, moisture, and great pressure to form a felt material which is then mounted between the outer cloth 1 and the inner lining 2.

For constructing sweaters or underwears, as shown in FIG. 2, in order to reduce the thickness of the cloth as much as possible to provide a more touching comfort to the wearer, the cotton or fibers would be spun into threads which are weaving or knitting into sheets of heat insulating cloth 3′ for sewing into the sweaters and underwears. However, since the fiber layer 3 of the compound textile material for jacket and coat provides better air layer for heat insulation than the heat insulating cloth 3′ knitted from the woven, cotton or fiber threads. Therefore, most of the users still prefer to wear jacket and coat while still tolerating the restriction of body activities.

However, the conventional compound fiber cloth has the following drawbacks.

The compound textile material is inflexible. During exercise, the conventional fiber layer 3 of the jacket or coat may be stretched by the movement of the wearer, as shown in FIG. 3. So, the density of the stretched portion of the fiber layer 3 of the compound textile material will be reduced, which will distort the shape of the compound textile material. In other words, the fiber layer 3 having a predetermined thickness will be getting thinner because of the stretched of the compound textile material. Once the compound textile material is stretched, it fails to be reformed to its original shape. So, the heat insulation feature of the compound fiber cloth will be gradually lost over a period of continued use.

By substituting other artificial and synthetic fiber materials of the fiber layer 3 such as plastic cotton, polyester, ferrous fiber, etc, some drawbacks of the compound fiber cloth may be improved. However, other drawbacks such as greater varying factor or higher shrink ratio may occur. In order to improve the above problems, an alternative is sought for.

In addition, since the compound textile material is preserved for heat insulation, while perspiration, the heat from the wear's body cannot directly transfer to the atmosphere. So, the body humidity will be highly increased. In other words, the sweat will remain on the wear's skin without being vaporized. However, the sweat will cool down the body temperature faster so that the wear may feel cold after perspiration in a short period of time. So, the compound fiber cloth has poor permeability.

No athlete and sporter like to wear the woven or insulating fiber made underwears because the nature of woven and synthetic fibers does not absorb sweat that may instantly increase the body humidity and cause uncomfortable feelings. Moreover, after the sporting and exercising, the sweat that will retain between the wearer's body and the sweater or underwear may cool down within a very short time that may make the athlete or sporter feel cold and even catch cold accordingly.

### SUMMARY OF THE PRESENT INVENTION

A main object of a heat-preserving compound fiber cloth and a manufacturing process thereof according to the present invention is to provide better heat insulation and flexibility while having a minimum thickness for making interior wears, such as vests, long johns, sweaters and underwears.

Another object of the present invention is to provide a heat-preserving compound fiber cloth, which has good flexibility so as to prevent the compound fiber cloth being misshaped or distorted while it is stretched. Therefore, the compound fiber cloth is capable of remaining the heat-preserving feature over a period of continued use.

Another object of the present invention is to provide a heat-preserving compound fiber cloth, which is excellent for making sports sweaters and underwears that the wearers have to do a lot of body stretches during exercising and sporting because the heat-preserving compound fiber cloth can reform is structure and thickness after the stretching force applied thereto is released.

Another object of a heat-preserving compound fiber cloth and a manufacturing process thereof according to the present invention is to provides better humidity-conductivity than the prior arts by providing porosity to air that is sufficient to avoid heat discomfort of the wearer during exercising.

Another object of the present invention is to provide a humidity conductivity and heat-preserving compound fiber cloth which retains good permeability for reducing the wearer's body humidity while perspiration. In other words, the sweat is capable of vaporizing through the compound fiber cloth while maintaining the wearer's body temperature.

Accordingly, in order to accomplish the above objects, the present invention provides a heat-preserving compound fiber cloth, comprising:

a sheet of outer fabric;

a sheet of inner fabric; and

a sheet of heat insulating layer, having a predetermined uniform thickness, comprising at least a fiber layer comprising a plurality of fiber filaments bonded on a construction film having flexible ability and permeability, wherein the construction film firmly and integrally holds the fiber filaments of the fiber layer together in such a manner that the heat insulating layer is adapted for being stretched and retaining an original shape, wherein the heat insulating layer is bonded between the outer fabric and the inner fabric to form the heat-preserving compound fiber cloth.

Moreover, the present invention also provides a manufacturing proves of the heat-preserving compound fiber cloth as described above, which comprises the steps of:

(a) providing at least one construction film;

(b) forming a heat insulating layer by attaching a plurality of fiber filaments on at least one side surface of the construction film which firmly and integrally holds the fiber filaments in position so as to form at least a fiber layer with a predetermined thickness on the side surface of the construction film;

(c) providing a sheet of outer fabric and a sheet of inner fabric; and

(d) bonding the heat-insulating layer between the outer fabric and the inner fabric.

### BRIEF DESCRIPTION OF THE DRAWINGS

FIG. 1 is a sectional view of a conventional compound textile material for constructing coats or jackets.

FIG. 2 is an exploded perspective view of the conventional heat insulation cloth for constructing underwear.

FIG. 3 is a sectional view of the conventional compound textile material, illustrating the conventional compound textile material being stretched.

FIG. 4 is an exploded perspective view of a heat-preserving compound fiber cloth according to a preferred embodiment of the present invention.

FIG. 5 is a sectional view of the heat-preserving compound fiber cloth according to the above preferred embodiment of the present invention.

FIG. 6 is a sectional view of a heat insulating layer of the heat-preserving compound fiber cloth according to the above preferred embodiment of the present invention, illustrating the heat insulating layer being stretched.

FIG. 7 is a block diagram of a manufacturing process of the heat-preserving compound fiber cloth according to the above preferred embodiment of the present invention.

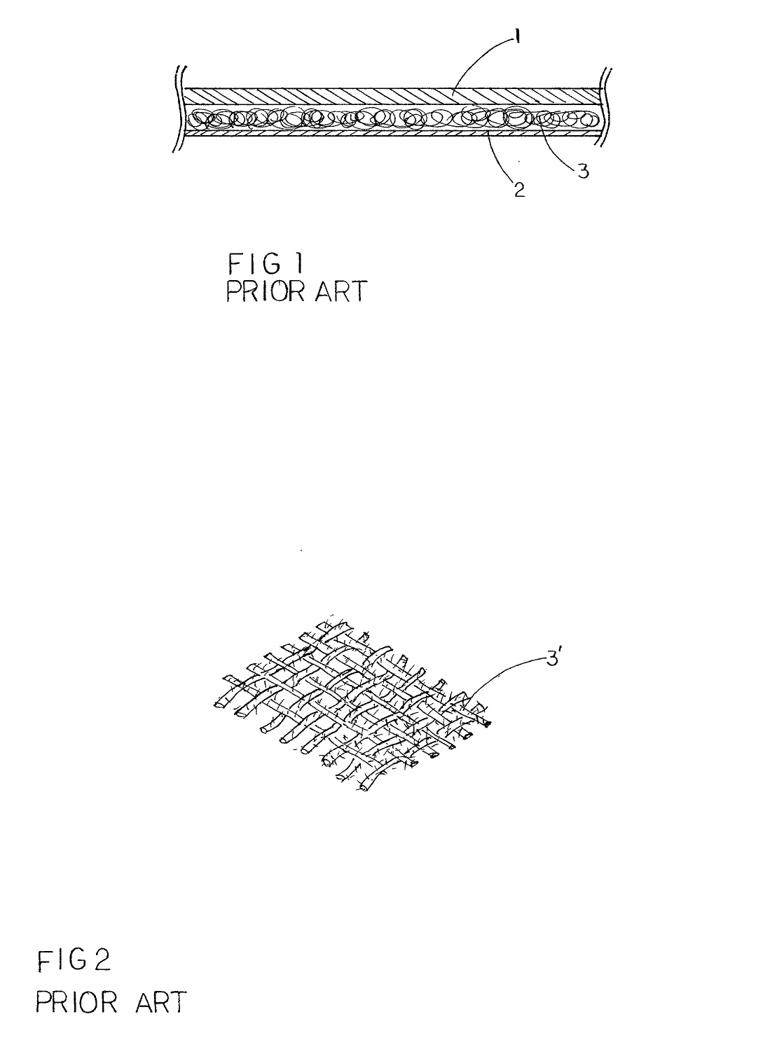

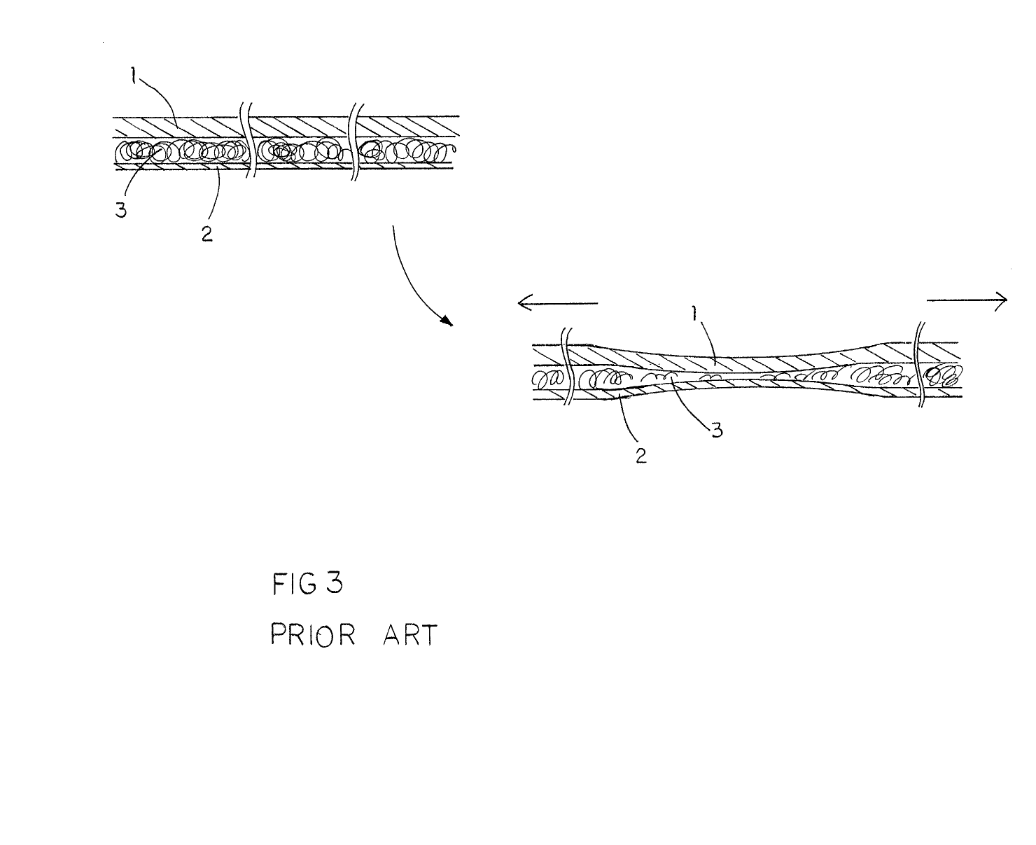

### DETAILED DESCRIPTION OF THE PREFERRED EMBODIMENT

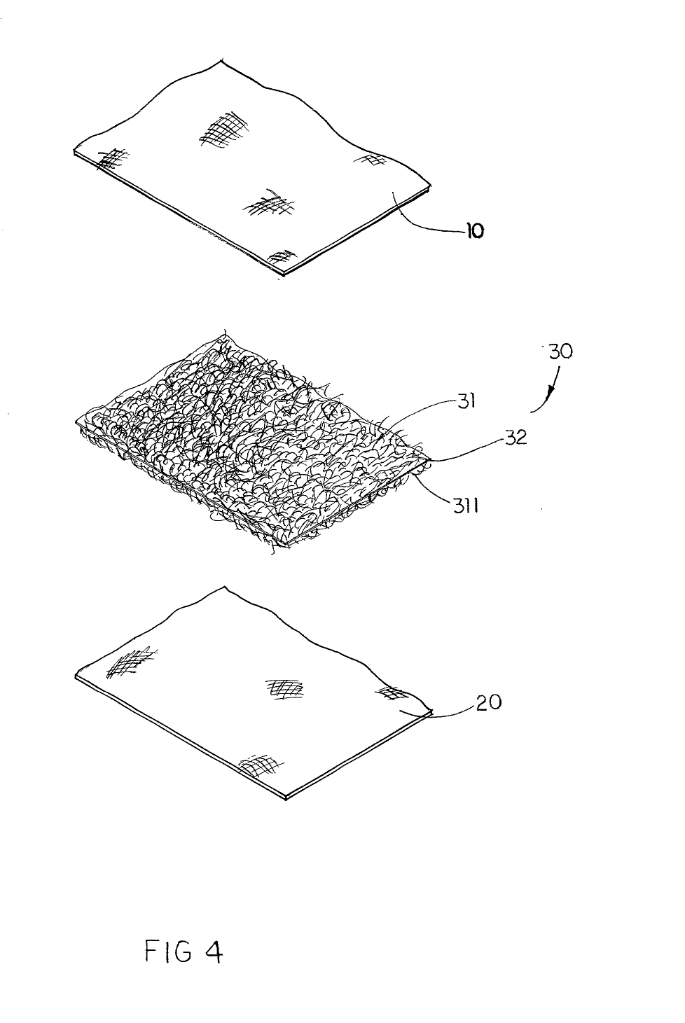

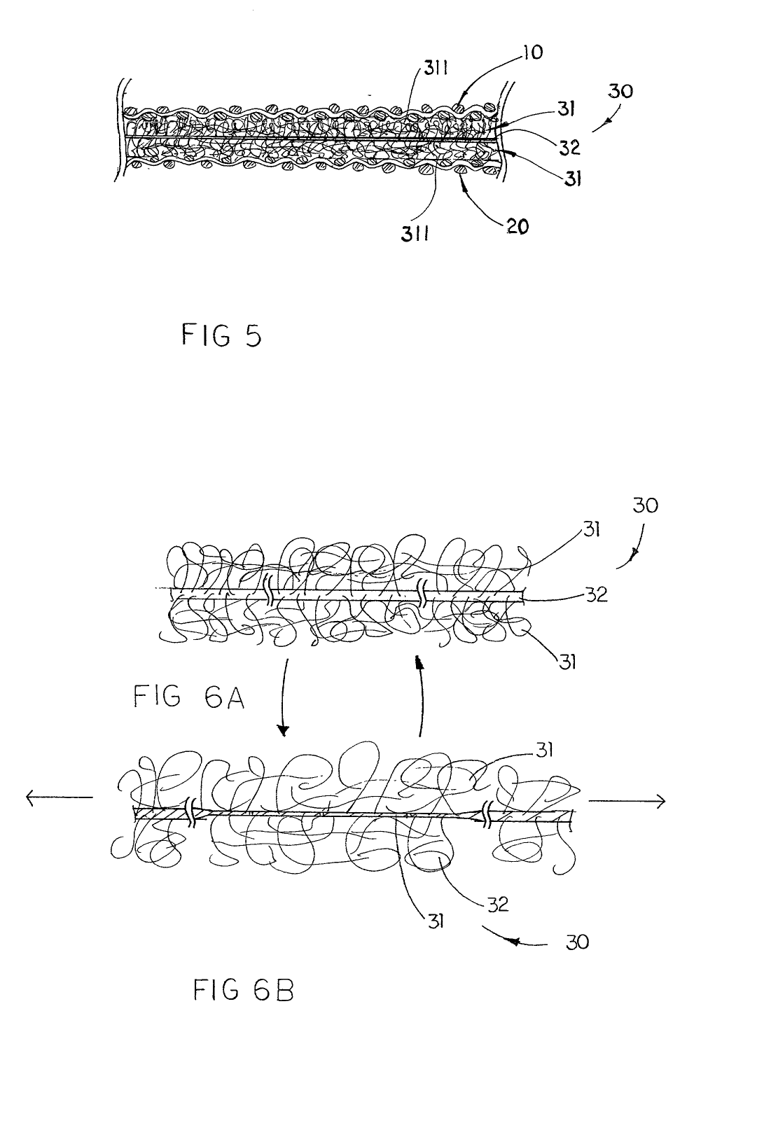

Referring to FIGS. 4 and 5 of the drawings, a heat-preserving compound fiber cloth is illustrated. The compound fiber cloth is adapted for manufacturing underwears, blankets, sleeping bags, or the like, which has both the ventilating and heat insulating abilities.

The compound fiber cloth comprises a sheet of outer fabric 10, a sheet of inner fabric 20, and a sheet of heat insulating layer 30 bonded between the outer fabric 10 and the inner fabric 20.

The sheet of heat insulating layer 30 has a predetermined uniform thickness and comprises at least a fiber layer 31 which comprises a plurality of fiber filaments 311 bonded on a construction film 32 having flexibility and permeability. The construction film 32 firmly and integrally holds the fiber filaments 311 together to form the fiber layer 31, such a manner that the heat insulating layer 30 is adapted for being stretched and retaining an original shape so as to provide ventilating and heat insulating effects.

Accordingly, the outer fabric 10 and the inner fabric 20 can be made of any material that fit for the products; however it is preferable to be made of flexible material. For example, when the product is the underwear, the outer fabric 10 and the inner fabric 20 should be made of stretchable and flexible fabric, such as cotton, that should be non-irritant, comfortable to wear. The inner fabric 20 should provide a soft surface in contact with human skin and is relatively close fitting to the wearer. When the product is a blanket or a sleeping bag, the outer fabric 10 should be durable and launderability because the outer fabric 10 is exposed to surroundings and protects the heat insulating layer 30. So, the outer layer 10 should last for a long time and preferable made of polyester fabric.

According to the preferred embodiment, the heat insulating layer 30 comprises two fiber layers 31 bonded on two side surfaces of the construction film 32 respectively. In other words, both side surfaces of the construction film 32 firmly hold and retain a predetermined thickness of the plurality of fiber filaments 311 thereon. However, the heat insulating layer 30 can be constructed by one single fiber layer 31 bonded on only one side surface of the construction film 32 or two construction films 32 bonded on one single fiber layer 31 at both side surfaces of the construction film 32 respectively, which depends on the usage of the product. It is worth to mention that we can increase the heat-preserving ability of the compound fiber cloth of the present invention simply by increasing the thickness of the fiber layer. Also, when the compound fiber cloth is used for constructing a blanket or sleeping bag as the product, more layers of the construction films 32 and the fiber layers 31 can be bonded together in sequence.

In other words, it is possible to made the heat insulating layer 30 including two or more construction films 32 and three or more fiber layers 31. For example, if there are two construction films 32, a first fiber layer 31 can be attached to an outer side surface of the first construction film 32, a second fiber layer can be attached to an outer side surface of the second construction film 32, and a third fiber layer can be bonded between the two inner side surfaces of the first and second construction films 32.

Each fiber layer 31 is made of fluff fiber which can be an artificial fiber, a synthetic fiber, or a natural fiber, such as velvet, cotton, silk floss, or plastic cotton, wherein the fiber layer 31 provides an insulating effect that heat can be preserved by the fiber layer 31. Preferably, each fiber layer 31 has a thickness approximately 0.4 to 1.8 mm.

The construction film 32, having stretchable and flexible ability, is made of a thin synthetic membrane such as ethylene-vinyl acetate copolymer, wherein the construction film 32 is adapted for providing a ventilating effect of the compound textile compound. Tiny pores may be formed on the construction film 32 for permeability. As shown in FIG. 3, a uniform density of fiber filaments 311 are attached on the two entire side surfaces of the construction film 32. In other words, each section of the construction film 32 provides a predetermined density of the fiber layer 31 coated thereon.

Since the construction film 32 has the stretchable and flexible ability, the heat insulating layer 30 is adapted for being stretched and retaining its original shape thereof. If both the outer fabric 10 and the inner fabric 20 for bonding the heat insulating layer 30 of the present invention therebetween are made of stretchable and flexible material, when a section of the heat insulating layer 30 is stretched, a corresponding section of the construction film 32 is enlarged but the density of the fiber layer 31 within the stretched section of the construction film 32 will remain the same, as shown in FIG. 6. However, the density of the fiber layer 31 per the stretched section of the construction film 32 will be decreased in such a manner that air can pass through the stretched section of the construction film 32 from one side of the heat insulating layer 30 to the other side thereof.

The construction film 32 is adapted for being stretched and condensed so as to function the ventilating and the insulating effects respectively. In normal condition, there is no stretching force applied on the compound fiber cloth, i.e. the heat insulating layer 30 is not being stretched, so that the fiber layer 31 is gathered together, as shown in FIG. 6A, to prevent air from being exchanged or passing through from one side of compound fiber cloth to another side thereof. Therefore, the heat insulating layer 30 provides the insulating effect in the normal condition.

The heat insulating layer 30 is bonded between the outer fabric 10 and the inner fabric 20 by pressurized, wherein adhesive is applied to the inner surfaces of both the outer fabric 10 and the inner fabric 20 and a predetermined pressure is applied to the outer fabric 10 and the inner fabric 20 between a pair of rolls such that the two fiber layers 31 of said heat insulating layer 30 are tightly adhered with the outer fabric 10 and the inner fabric 20 respectively.

When a stretching force is applied on the compound fiber cloth, i.e. the heat insulating layer 30 is being stretched, the area of the construction film 32 is being enlarged so as to enable air penetrating therethrough for ventilation, as shown in FIG. 6b.

In other words, when the wearer has no exciting movement, which is in the normal condition, the compound fiber cloth provides the insulating effect to maintain the wearer's body temperature so as to keep himself or herself warm. However, when the wearer is excising, which will apply stretching force on the compound fiber cloth, the heat-insulating layer 30 is stretched out for providing ventilating effect for the compound fiber cloth such that the sweat on the wear's skin from perspiration can be vaporized by ventilation. Furthermore, the bigger movement the wearer has, the larger area of the construction film 32 being enlarged. So, the wearer will feel comfortable because heat can be dispersed to the atmosphere.

It is worth to mention that the flexible construction film 32 will help the fiber layer 31 not to be distorted its shape while the heat insulating layer 30 is stretched which may cause permanently misshapen at the stretched section of the heat insulating layer 30 as described of the conventional compound fiber cloth in the background.

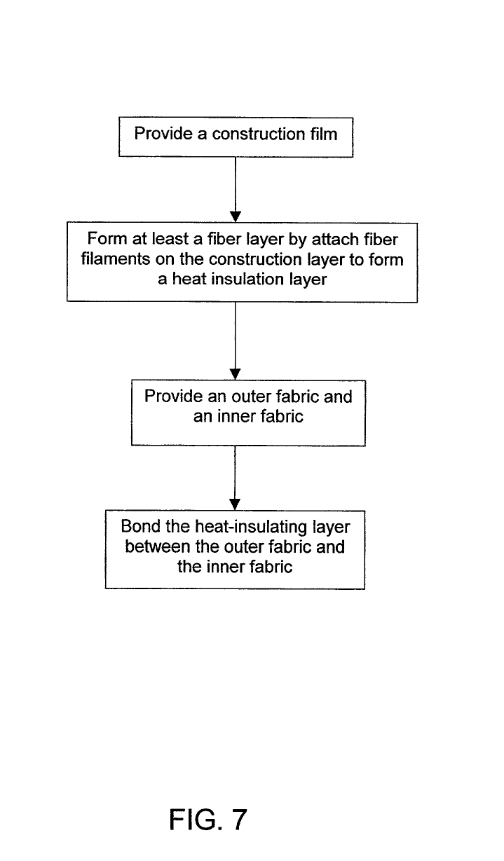

Referring to FIG. 7, a manufacturing process of the heat-preserving compound fiber cloth is illustrated, which comprises the following steps.

(a) Provide at least one construction film 32.

(b) Form a heat insulating layer 30 by attaching a plurality of fiber filaments 311 on at least one side surface of the construction film 32 which firmly and integrally holds the fiber filaments 311 in position so as to form at least a fiber layer 31 with a predetermined thickness on the side surface of the construction film 32.

(c) Provide a sheet of outer fabric 10 and a sheet of inner fabric 20.

(d) Bond the heat-insulating layer 30 between the outer fabric 10 and the inner fabric 20.

In the step (b), the fiber layer 31 is bonded on the construction film 32 by pressurized between a pair of rolls until the fiber filaments 311 are attached on the respective side surface of the construction film 32 so as to form the fiber layer 31. Therefore, the fiber layer 31 is tightly coated on the construction film 32 to form the heat-insulating layer 30 with a predetermined thickness.

In the step (d), the heat-insulating layer 30 is tightly adhered between the outer fabric 10 and the inner fabric 20 by pressurized between a pair of rolls. After the step (d), the steps of cutting the compound fiber cloth into a predetermined shape, checking the quality of the compound fiber cloth, and packaging can be preformed.

In accordance with the preferred embodiment as disclosed above, the heat-preserving compound fiber cloth of the present invention is adapted for manufacturing a textile product that provides both ventilating and heat insulating effects. Due to the stretchable properties of the construction film 32, the compound fiber cloth is adapted for being stretched without permanently distorting its shape. So, the compound fiber cloth can be long lasting over a period of continued use.

What is claimed is:

1. A heat-preserving compound fiber cloth, comprising a sheet of outer fabric; a sheet of inner fabric; and a sheet of heat insulating layer, having a predetermined uniform thickness, comprising at least a fiber layer comprising a plurality of fiber filaments bonded on at least a construction film having a predetermined flexible ability, wherein said construction film firmly and integrally holds said fiber filaments of said fiber layer together in such a manner that said heat insulating layer is adapted for being stretched and retaining an original shape, wherein said heat insulating layer is bonded between said outer fabric and said inner fabric to form said heat-preserving compound fiber cloth.

2. A heat-preserving compound fiber cloth, as recited in claim 1, wherein said construction film is a thin synthetic membrane.

3. A heat-preserving compound fiber cloth, as recited in claim 2, wherein said construction film is made of ethylene-vinyl acetate copolymer.

4. A heat-preserving compound fiber cloth, as recited in claim 1, wherein said heat insulating layer comprises two fiber layers bonded on both side surfaces of said construction film respectively.

5. A heat-preserving compound fiber cloth, as recited in claim 2, wherein said heat insulating layer comprises two fiber layers bonded on both side surfaces of said construction film respectively.

6. A heat-preserving compound fiber cloth, as recited in claim 3, wherein said heat insulating layer comprises two fiber layers bonded on both side surfaces of said construction film respectively.

7. A heat-preserving compound fiber cloth, as recited in claim 4, wherein said two fiber layers of said heat insulating layer is tightly adhered with said outer fabric and said inner fabric respectively wherein during manufacturing, a predetermined pressure is applied to said outer fabric and said inner fabric so as to firmly bond said heat insulating layer between said outer fabric and said inner fabric.

8. A heat-preserving compound fiber cloth, as recited in claim 6, wherein said two fiber layers of said heat insulating layer is tightly adhered with said outer fabric and said inner fabric respectively, wherein during manufacturing, a predetermined pressure is applied to said outer fabric and said inner fabric so as to firmly bond said heat insulating layer between said outer fabric and said inner fabric.

9. A heat-preserving compound fiber cloth, as recited in claim 1, wherein said outer fabric and said inner fabric are made of stretchable and flexible material, and said construction film having stretchable and flexible ability and providing a ventilating effect for said compound textile compound.

10. A heat-preserving compound fiber cloth, as recited in claim 4, wherein said outer fabric and said inner fabric are made of stretchable and flexible material, and said construction film having stretchable and flexible ability and providing a ventilating effect for said compound textile compound.

11. A heat-preserving compound fiber cloth, as recited in claim 5, wherein said outer fabric and said inner fabric are made of stretchable and flexible material, and said construction film having stretchable and flexible ability and providing a ventilating effect for said compound textile compound.

12. A heat-preserving compound fiber cloth, as recited in claim 6, wherein said outer fabric and said inner fabric are made of stretchable and flexible material, and said construction film having stretchable and flexible ability and providing a ventilating effect for said compound textile compound.

13. A heat-preserving compound fiber cloth, as recited in claim 8, wherein said outer fabric and said inner fabric are made of stretchable and flexible material, and said construction film having stretchable and flexible ability and providing a ventilating effect for said compound textile compound.

14. A heat-preserving compound fiber cloth, as recited in claim 1, wherein said fiber layer has a thickness between 0.4 mm and 1.8 mm.

15. A manufacturing process of a heat-preserving compound fiber cloth, comprising the steps of:
(a) providing at least one construction film;
(b) forming a heat insulating layer by attaching a plurality of fiber filaments on at least one side surface of said construction film which firmly and integrally holds said fiber filaments in position so as to form at least a fiber layer with a predetermined thickness on said side surface of said construction film;
(c) providing a sheet of outer fabric and a sheet of inner fabric; and
(d) bonding said heat-insulating layer between said outer fabric and said inner fabric.

16. The manufacturing process, as recited in claim 15, wherein in the step (b), said fiber layer is bonded on said construction film by pressurized between a pair of rolls until said fiber filaments are attached on said respective side surface of said construction film so as to form said fiber layer.

17. The manufacturing process, as recited in claim 15, wherein in the step (d), said heat-insulating layer is tightly adhered between said outer fabric and said inner fabric by pressurized between a pair of rolls.

18. The manufacturing process, as recited in claim 16, wherein in the step (d), said heat-insulating layer is tightly adhered between said outer fabric and said inner fabric by pressurized between a pair of rolls.

19. The manufacturing process, as recited in claim 15, wherein said construction film is a thin synthetic membrane.

20. The manufacturing process, as recited in claim 17, wherein said construction film is a thin synthetic membrane.

21. A heat-preserving compound fiber cloth, as recited in claim 19, wherein in the step (b), said fiber filaments are attached to both side surfaces of said construction film.

22. A heat-preserving compound fiber cloth, as recited in claim 20, wherein in the step (b), said fiber filaments are attached to both side surfaces of said construction film.

23. A heat-preserving compound fiber cloth, as recited in claim 21, wherein said outer fabric and said inner fabric are made of stretchable and flexible material, and said construction film having stretchable and flexible ability and providing a ventilating effect for said compound textile compound.

24. A heat-preserving compound fiber cloth, as recited in claim 22, wherein said outer fabric and said inner fabric are made of stretchable and flexible material, and said construction film having stretchable and flexible ability and providing a ventilating effect for said compound textile compound.
